(19) United States
(12) Patent Application Publication
(10) Pub. No.: US 2003/0054154 A1
(43) Pub. Date: Mar. 20, 2003

(54) Method of making a porous green form and oxygen transport membrane

(76) Inventors: Hancun Chen, Williamsville, NY (US); Jack C. Chen, Getzville, NY (US)

Correspondence Address: PRAXAIR, INC., LAW DEPARTMENT - M1 557, 39 OLD RIDGEBURY ROAD, DANBURY, CT, 06810-5113, US

(21) Appl. No.: 09/951,955

(22) Filed: Sep. 14, 2001

(51) Int. Cl. B32B 3/26

(52) U.S. Cl. 428/305.5; 428/307.3

(57) ABSTRACT

A method of making a porous, green form for use in producing at least part of an article that can be an oxygen transport membrane. A green powder, a binding agent, and first and second pore forming, particulate materials are mixed together. The first and second pore forming, particulate materials have first and second particle sizes such that the first particle size is greater than the second particle size. The difference in pore forming particle sizes allows for the production of large pores and channels connecting the pores in the finished article or part thereof. Advantageously, the first pore forming material is a sublimable material such as naphthalene. The mixture is formed into a configuration suitable for the use within the article, for instance a tube formed by extrusion. The first pore forming material is removed to form the pores. The oxygen transport membrane can have a dense layer supported by one or more porous support layers formed by a green form of the present invention.

### FIELD OF THE INVENTION

The present invention relates to a method of manufacturing a porous green form for use in producing at least a porous component part of an article. More particularly, the present invention relates to such a method in which two different size pore forming materials are used to respectively form pores and channels connecting the pores within the porous component part or the article. In another aspect the present invention relates to an oxygen transport membrane having a dense layer and a porous support fabricated from the porous green form.

### BACKGROUND OF THE INVENTION

Inorganic membranes have been widely used for many different applications. There are several types of inorganic porous membranes, for example, metallic membranes, polymer membranes, and porous ceramic membranes. Polymer membranes are commonly used in the processing of fine particles, colloids and biological materials such as protein precipitates and microorganisms. Porous ceramic membranes, due to their inertness towards various chemicals, bacteria and high temperatures, have found increasing application in chemical industries for gas separation and purification. Depending on the pore size, porous ceramic membranes can be utilized in either microfiltration, ultrafiltration, reverse osmosis, or gas separation.

In addition to the foregoing, ceramic membranes that do not depend on permeation, but rather, ion transport, have been used in separating oxygen-containing gas mixtures. Such ceramic membranes having infinite selectivity to oxygen are known as an oxygen transport membranes. Oxygen transport membranes only allow oxygen ions to transport across the membranes with the exclusion of other elements and ions.

Oxygen transport membranes can be in the form of composite membranes that have a dense layer capable of conducting the oxygen ions and a porous support that provides mechanical strength while maintaining reasonably high permeability for the dense layer. In general, the oxygen flux across an oxygen transport membrane is inversely proportional to the thickness of the membrane. Thus, thinner membranes lead to higher fluxes, reduced area, and lower operating temperatures. Hence, a very thin dense layer can be seen to be particularly advantageous. It is to be noted that an additional porous intermediate supporting layer can be located between an inert porous support and the dense layer to provide a further increase oxygen flux.

It has been identified that gas diffusion through the porous support limits the flux performance of the composite oxygen transport membrane. It is important to reduce the gas diffusion resistance of the porous support to achieve a high flux. Therefore, fabrication of robust porous supports with large pores, greater than about 20 μm in diameter and high permeability provided by a porosity of greater than about 40% are critical to the performance characteristics of composite oxygen transport membranes. As may be appreciated, similar design considerations can apply to porous inorganic membranes when a high degree of permeability is required.

Currently, porous substrates with porosity of between about 30% and about 35% and with pore diameters varying anywhere from about 1 to about 10 μm are fabricated by introducing certain amounts of binder and pore former (e.g. starch, graphite, pure cellulose, sawdust) into starting powder materials and thereafter burning off the pore former and binder and sintering the green body at desired temperatures. To fabricate highly porous substrates, pore diameters that are greater than about 20 μm and porosities greater than about 40%, large amounts of pore former are usually introduced into the powder mixture. However, it is very difficult to remove the large amounts of pore forming material because severe exothermic reactions occur during the burn-off stage that tend to cause breakage in the ceramic components. As a result, a slow heating and controlled atmosphere process is used for the burn-off process to avoid the severe exothermic reactions. As may be appreciated, this slow heating process is very difficult to scale up for mass production.

U.S. Pat. No. 5,252,525 discloses the production of high temperature ceramic particulate filters in which a mixture of refractory cement aggregate, pore forming additives and sintering agents is cast into the desired form. The pore forming additives can be formed of synthetic or organic powders or fibers that sublimate, melt or otherwise disintegrate to produce pores in the cement. Suitable pore forming additives include polyethylene, polypropylene, polyester, sawdust, and naphthalene. As may be appreciated, very tough elements are produced having a porosity of between about 50% and about 57%.

Another manufacturing technique is disclosed in U.S. Pat. No. 6,153,547. In this patent, a flowable mixture made up of an aqueous polymer dispersion, a sinterable powder and a dispersant are introduced into a precipitation bath to cause the polymer to precipitate or coagulate. The precipitation of the polymer forms a non-flowable powder mixture. After drying, the powder mixture is removed from polymer. The resultant sintered support formed from the powder mixture can have a porosity of between about 50% and about 95%. Pore diameters within the support can be between about 20 μm and about 500 μm. Another example is disclosed in U.S. Pat. No. 6,087,024 that teaches the production of porous sintered bodies with controlled pore structure. In accordance with the teachings of this patent, a non-solvent-based polymer is introduced into a powder having a particle size of about 400 μm. The sintered foam have a controlled open porosity up to about 80%, low firing shrinkage, and unique pore morphology. However, porous articles fabricated by this method do not have the strength required for many applications. For instance, such manufacturing method would not be suitable for fabricating composite oxygen transport membranes.

In another prior-art method, shown in U.S. Pat. No. 5,824,220, a ceramic powder is blended with a ceramic fiber or additive, a binder and/or small amounts of pore former if desired. The shaped body is then heat-treated at elevated temperatures to obtain the porosity. The porosity and pore diameters of the ceramic porous supports so prepared depend on the type, particle size, and the amount of the ceramic fiber and additive. Typically a porosity of between about 25% and about 40% can be obtained with pore diameters of less than 10 μm. A porous support or other article fabricated using such methodology are expensive due to the use of high-purity ceramic fibers.

In yet another method, a porous metal or ceramic is fabricated through the use of a thermal spray process. This is a very efficient manufacturing method because there is no need of high temperature sintering. Normally, a starting powder is mixed with certain amount of pore forming material to form a powder mixture. The powder mixture is fed into thermal spray gun in which the powder mixture is heated by plasma and deposited on the substrate. Because the pore forming material in the powder mixture gasifies during the deposition processes, the sprayed coating remains porous. Porosity of the porous coating can be as high as about 40%. A porous structure fabricated by this process is described in U.S. Pat. No. 4,759,957 in which a metal powder mixed a meltable polymer is plasma-sprayed to fabricate a highly porous metal deposit (porosity up to about 68%) for abradable seals used in gas turbine engines. Major drawbacks of such methodology include high initial equipment investment, low deposition efficiency, and the lack of applicability of such method to the fabrication of free-standing, hollow porous structures.

The above discussion demonstrates that although there exist a wide variety of prior art techniques to manufacture porous articles, there exists a trade off between the degree of porosity and pore diameter with the strength of the finished article and/or the manufacturing difficulty and expense involved in producing a porous article with a high degree of permeability.

As will be discussed in further detail, the present invention provides a method of producing a porous green form that is useful in forming a robust porous article or a robust porous component part of an article with a large pore diameter and a high degree of permeability. The use of the porous green form of the present invention allows such porous articles or porous component parts to be produced with less complexity and expense than prior art techniques.

### SUMMARY OF THE INVENTION

The present invention provides a method of making a porous, green form for use in producing at least part of an article. Thus, the present invention has applicability to a wide variety of porous structures including the production of porous supports for oxygen transport membranes and porous articles such as inorganic porous membranes.

In accordance with the method, a green powder, a binding agent, and first and second pore forming, particulate materials are combined to form a mixture. The first pore forming, particulate material has a first particle size greater than a second particle size of the second pore forming, particulate material. This allows the first and second pore forming, particulate materials to produce pores and channels bridging the pores, respectively, within the at least part of the article, upon removal of the first and second pore forming particulate materials. The mixture is formed into a configuration suitable for the use within the article. For instance, the configuration might be a tubular structure formed by extrusion or isopressing for use as a porous support or an inorganic porous membrane. At least the first pore forming, particulate material is removed from the mixture after the mixture is formed into the configuration to form the pores.

The first pore forming, particulate material is preferably a first substance capable of being removed by sublimation and the first substance is removed from the mixture by sublimation, after the mixture is formed into the configuration of the green form and prior to removal of the second substance. Such first substance can be naphthalene and the second substance can be carbon or starch. Starch is particularly preferred due to its known enhanced moisture absorbing capability. The green form can be heated or subjected to a subatmospheric pressure to accelerate the sublimation.

Preferably, the second particle size is between about 5 and about 30 times smaller than the first particle size. The second substance can preferably be present within the mixture in a range of between about 5% by weight and about 20% by weight. In such case, the second substance is removed by burning off the second substance.

The green powder can be a ceramic membrane material capable of conducting oxygen ions. Alternatively, the green powder can be a non-oxygen ion conducting ceramic material comprising alumina or magnesium oxide. As another possibility, the green powder can be a metallic material.

In another aspect, the present invention provides an oxygen transport membrane that is provided with a dense layer and at least one porous support layer connected to the dense layer. The porous support layer has pores and channels having average diameters less than that of the pores connecting the pores. In case of a pressure driven oxygen transport membrane, the dense layer and the at least one porous support layer are formed from ceramic materials capable of conducting oxygen ions and elections. Preferably, the dense layer and the at least one porous support layer are formed from the same material. The dense layer can have a thickness in a thickness range of between about 1 μm and about 1000 μm. The pores can have an average pore diameter in a pore diameter range of between about 0.1 μm and about −200 μm. Preferably the average pore diameter range is between 20 μm and about 100 μm. “Average pore diameter” as used herein and in the claims means the pore diameter as determined by mercury porosimetry. The channels can have an average channel diameter of between about 5 and about 30 times smaller than the average pore diameters and the least one porous support layer can have a porosity of between about 30% and about 50% by volume.

In the present invention, the use of two different size pore formers allows for the production of a highly permeable structures with large pore sizes that is sufficiently robust to serve in applications where strength is a major prerequisite for the structure. Specific aspects of the present invention allow such structures to be produced by simpler and more cost-effective techniques than the prior art. For instance, the use of a sublimable material such as naphthalene to produce the pores prior to firing allow large pores to be produced without the long heating times required to burn out pore forming materials of the prior art having a large particulate size. At the same time, the smaller channel producing pore forming materials can be rapidly removed by burning the same without breakage of the material. As such, methods of the present invention can be inexpensively scaled up to allow for large scale production.

### BRIEF DESCRIPTION OF THE DRAWINGS

While the specification concludes with claims distinctly pointing out the subject matter that Applicants regard as their invention, it is believed that the invention will be better understood when taken in connection with the accompanying drawings in which:

FIG. 1 is a photograph of an image produced by an electron microscope of a cross-section of a ceramic structure formed by a porous green form of the present invention;

FIG. 2 is a graphic depiction of a comparison between the permeability of the ceramic structure of FIG. 1 and prior art ceramic structures; and

FIG. 3 is a photograph of an image produced by an electron microscope of a cross-section of a ceramic structure useful in forming an oxygen transport membrane in which a porous support thereof was produced by a porous green form of the present invention.

### DETAILED DESCRIPTION

It has been found by the inventors herein that porous structures having large pores with high connectivity between the pores by provision of channels produces a structure having both mechanical strength and a high degree of permeability. This is effectuated in the present invention through the use of a porous green form used in fabricating the porous structure. The porous green form of the present invention is made with the use of two particulate, pore forming materials, one having a large particle size to produce pores in the porous green form and the other having a small particle size to produce the channels within the porous structure.

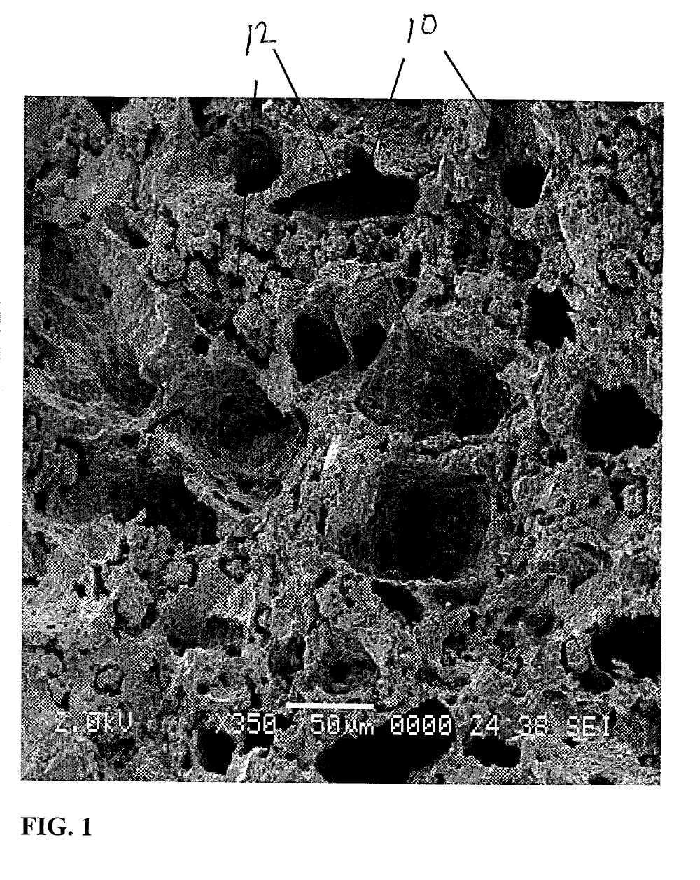

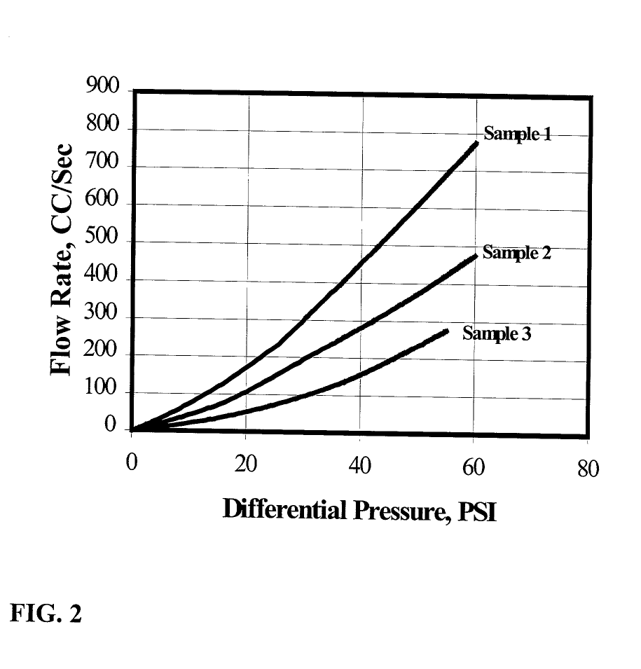

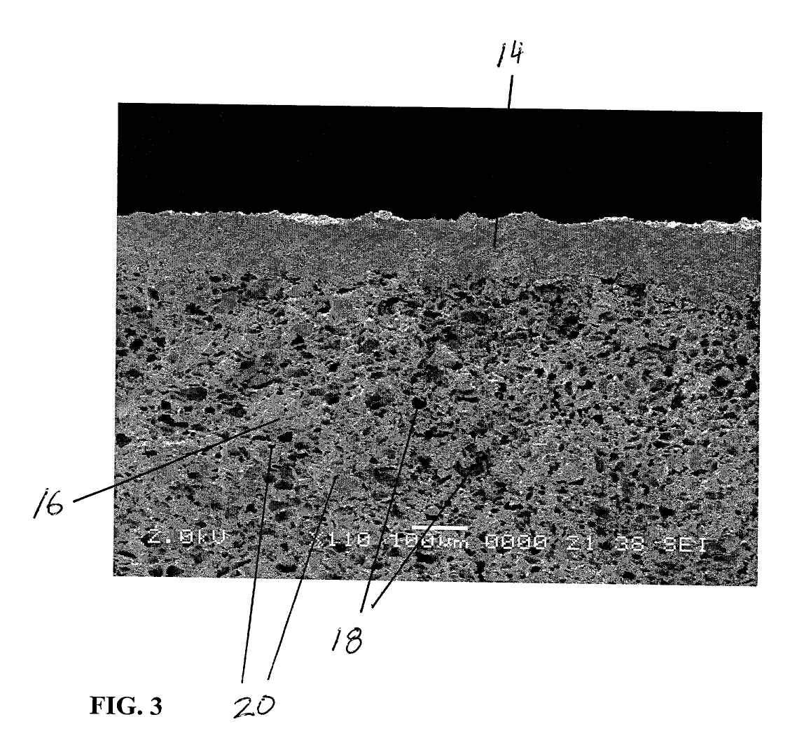

With reference to FIG. 1, a porous ceramic structure is shown that is formed by a porous green form of the present invention. The porous structure is provided with large pores 10 and channels 12 connecting the large pores 10. The formation of this structure is discussed in greater detail in Example 1, set forth below. FIG. 2, also discussed in greater detail with respect to Example 1, is a comparative example showing the improved permeability of the porous structure of FIG. 1 as compared with porous structures having smaller pores. FIG. 3 shows an oxygen transport membrane utilizing a porous support fabricated from a porous green form of the present invention. As shown in FIG. 3, a dense layer 14 is supported by a porous support 16 having large pores 18 and channels 20 connecting the large pores 18. FIG. 3 will be discussed in greater detail with respect to Example 2, set forth below.

As a first step in forming a green porous form of the present invention, a green powder, a binding agent, and the two particulate, pore forming materials are combined to form a mixture. This can be carried out by separately weighing the components. As will be discussed, it may be advantageous to mix the first and second particulate, pore forming materials and subject such pre-mixture to a grinding and wire mesh screening operations to grind and sort the first particulate, pore forming material to an appropriate size. After weighing, or if necessary, premixing the pore forming materials, the components of the mixture are then loaded into a plastic vial. The components in the vial are then mixed for a predetermined time period. There are a variety of known mixing processes that may be used for such purposes.

The green powder, either a ceramic or a metallic substance, preferably has a particle size in a range of between about 0.01 μm and about 100 μm, preferably from about 0.1 μm and about 20 μm, and more preferably from about 0.5 and about 5 μm.

The first of the two particulate, pore forming materials, the one with the larger particle size to produce the pores, is formed by a substance that is removed from a green form, produced from the mixture, prior to a second pore forming particulate material used in forming the channels. Preferably, the first pore forming, particulate material is a substance that can be removed from the mixture by sublimation. Such a sublimation material can be any volatile material having a low sublimation temperature, for instance naphthalene. Any commercial naphthalene, preferably in the form of particulate, can be used in connection with the present invention. The particle size of naphthalene should be less than about 500 μm, preferably less than 100 μm. The naphthalene content in the mixture is in a range of between about 5% and about 80% by weight, preferably from about 10% to about 50% by weight.

It is to be noted that the selection of the particle size for the first particulate pore forming material, preferably naphthalene, is dependent upon the intended use of the fired and sintered article. For instance, pores that are greater than about 200 μm in diameter are not suitable for composite oxygen transport membrane applications because large pores either make the porous support too weak to handle or make it difficult to deposit dense films on the support without having the deposition completely close the pores. It is to be noted, though, extremely large pores in a support may be ideal in the other applications.

The second particulate pore forming material is preferably a substance designed to be removed from the green form through oxidation either during a separate burn-out phase or during the sintering of the green form to produce the finished article or article component. Such material can be formed from starch or graphite. The ratio between naphthalene and starch (or graphite) and the total amount of pore former depend on the application requirements of the porous supports. For example, in the case of the composite oxygen transport membrane, the porous support should have the porosity from between about 30% and about 50% in order to obtain high oxygen flux performance. Therefore, the total amount of the particulate pore forming materials should be present within the mixture in a range of between about 20% and about 40% by weight. The ratio between the naphthalene and the starch (or graphite) is preferably in a range from between about 20:1 and about 2:1, preferably from between about 5:1 and about 3:1.

The addition of the second particulate pore forming material has two advantages. As stated above, the second particulate pore forming material increases the connectivity of the larger pores produced by the first particulate pore forming material within the fired article to help increase permeability while not comprising the structural integrity of the fired article. Preferably, the particle size of such second particulate pore forming material used for this purpose is between about 5 and about 30 times smaller than that of the first particulate pore forming material resulting in average channel diameters being smaller than the pores in the foregoing ratio. The small particles in addition to adding connectivity also act to uniformly distribute the larger particles to prevent a concentration of the larger particles.

The use of starch or graphite as the second particulate pore forming material with naphthalene as the first particulate pore forming material is particularly advantageous. Commercially available naphthalene powder is usually too coarse to be used for purposes of the present invention. It needs to be further ground and processed with the use of a screen to obtain an appropriate size and thereby avoid the formation of very large pores. It is difficult to carry out the grinding and screening of naphthalene because naphthalene powder particles tend to form agglomerates, resulting in difficulty in controlling its particle size. When the coarse naphthalene powder, however, is blended with a certain amount of starch (or graphite) into a pre-mixture, as discussed above, the difficulty attendant to such grinding and screen is reduced because the small starch or graphite particles can act as separators between the naphthalene particles to prevent the agglomeration of naphthalene.

After the mixing is complete, the mixture is formed into a desired configuration of the green form and therefore, the finished article or component thereof. For instance, if a tubular configuration is required, the forming operation can be carried out by extrusion or isopressing.

After the green form is produced, the first particulate pore forming material is removed to produce the porous green form of the present invention. In case of naphthalene, the removal process can be at room temperature due to its low sublimation temperature. The time required for such process depends on the volume of the green form. The naphthalene removal time can be greatly reduced if the green body is keep in the low temperature oven or on a hot plate, less than about 70° C. or under a vacuum. The naphthalene removal process can be monitored by weighing the green form at regular time intervals and by comparing to the amount originally added to the sample.

After the removal of the first particulate, pore forming material, the second particulate, pore forming material is then removed by a separate burn-off process or during the firing and sintering of the green porous form. Whether or not a separate burn-off process is necessary for the combined pore former depends on the amount of starch (or graphite) in the green form. In the case that the starch (or graphite) content is less than about 5% by weight, a separate pore former burn-off process is not necessary. After naphthalene is removed from the green form, the porous green form of the present invention can be directly heated to the desired temperature for sintering at a heating rate from about 1 and about 10° C./minute, preferably from about 1 and about 3° C./minute.

In case that the starch (or graphite) content is greater than about 5% by weight, the pore former burn-off process is needed but not critical, because the naphthalene as a primary pore former, can be removed quickly at room temperature or oven or hot plate. The rest of starch (or graphite) pore former, if less than about 20% by weight in the mixture, can be removed easily by heating in a separate burn-off phase of the process at a temperature in a range from between about 250° C. and about 750° C. for between about 1 hour and about 3 hours at heating rates from between about 1° C./minute and about 2° C./minute. Greater concentrations of second particulate pore forming materials will of course increase processing times.

Assuming the second particulate pore forming material does not have to be removed through a separate stage of the process, the porous green form of the present invention is ready for sintering at the desired temperature to obtain the finished article. While sintering temperature depend on the type of green material to be sintered, it can be said that at least for ceramic materials, sintering temperatures commonly range from between about 1000° C. and about 1800° C. For the composite oxygen transport membrane materials used for oxygen separation, the sintering temperature is typically from between about 1100° C. and about 1300° C. Since there need for pore former burn-off during heating up to the sintering temperature does not exist or only exists to a limited extent, the heating rate can be between about 2° C./minute and about 20° C./minute as compared to prior art heating rates of between 0.2° C./minute and about 1° C./minute.

The porous ceramic structure fabricated using the combined naphthalene and starch (or graphite) pore former is particularly suitable to form a support layer of a composite oxygen transport membrane that is provided with a dense gas separation layer deposited on the porous support layer. By controlling the combined pore former, an ideal support for such a membrane will have a porosity from between about 30% and about 50% (as measured on a total porosity basis) and an average pore diameter from between about 0.1 μm and about 200 μm. The average pore diameter is preferably between about 20 μm and about 100 μm The dense layer has a thickness that is preferably between about 1 μm_and about 1000 μm. The porous support layer preferably has a thickness in a range of between about_{—}10 μm and about 3 mm. However, the actual thickness selected for the porous support layer will depend upon the type of and environment for the oxygen transport membrane being fabricated. In this regard, it is possible to have a series of porous support layers, each with larger pores that are formed by isopressing successive layers of green form onto previously formed green layers.

Many techniques can be used for deposition of the dense layer on the porous support layer. Examples of these techniques are thermal spray, colloidal/slurry co-firing processes, electrostatic spray pyrolysis, chemical vapor deposition, and electrochemical vapor deposition.

The materials forming the dense and porous support layers might be different, depending upon the type of oxygen transport membrane. For instance, in an electrically driven membrane, the dense layer would be formed from known ionic materials that are capable of conducting oxygen ions. The adjacent porous support layers would be formed from known electrode materials on an inert porous support. Alternatively, for pressure driven systems, both the porous support and the dense layer could be fabricated from mixed conductors capable of conducting both electrons and oxygen ions. As may be appreciated the present invention also encompasses oxygen transport membranes in which dual phase systems are used, for example dual phase conductors in which electrons are conducted by an electronically conductive phase and oxygen ions are conducted by an ion conducting phase.

High temperature permeation tests of a composite oxygen transport membrane using porous support fabricated under the present invention shows an increase of from about 15% to about 30% in oxygen flux at 1000° C. as compared to that using the porous support made by other methods.

The following are examples that describe porous articles fabricated from green forms using a ceramic powder composed of La_{0.2}Sr_{0.8}Fe_{0.8}Cr_{0.2}O₃ (hereinafter referred to as “LSFC”), naphthalene and different pore former mixtures. The purpose of the examples is to describe in detail the sample preparation of various green forms and ceramic articles fabricated from such green forms. The examples should not, however, be taking as limiting the invention in any way.

### EXAMPLE 1

Preparation of porous LSFC support with a combined pore former of 20% by weight naphthalene and 10% by weight starch.

About seventy grams of LSFC powder having an average particle size of about 1 μm, about twenty grams of naphthalene powder having particle sizes of less than about 100 μm, and 10 grams of starch having particle sizes less than about 10 μm were put into a plastic vial with a few methacrylate mixing balls. The LSFC powder contained a binding agent formed of about 5% by weight of polyvinyl alcohol and polyethylene glycol. The vial was then inserted into a SPEX CERTIPREP Mixer/Mill and mixed for 10 minutes. Seven and a half grams of the prepared powder mixture was loaded into a stainless steel mold with a diameter of 38 mm and pressed under the pressure of 60 about MPa for about 1 minute. After the pressure was released, the disc-shaped green body was withdrawn from the mold and put on the hot plate of 70° C. for 2 hours to remove the naphthalene pore former. The green form thus produced was then loaded into a furnace and the furnace was heated at about 1° C./minute in ambient air to a temperature of about 450° C. for about 1 hour to remove the starch pore former. The heating rate was increased to about 2° C./minute until of temperature of about 1250° C. was obtained. The temperature was held for about 4 fours in air. The furnace was cooled to room temperature at the rate of about 2° C./minute.

The ceramic porous body produced by the foregoing method was evaluated by SEM and measured for porosity using mercury porosimetry. This porous body is shown in FIG. 1. Pores 10 had a diameter from between about 20 μm and about 70 μm. The measured overall porosity was about 49%.

With reference again to FIG. 2, the permeability of three materials was compared. The first sample is the porous ceramic structure produced in this Example 1. The second sample was a commercial alumina structure having a porosity of about 35% and an average pore diameter of between about _{—}6 and about 10 μm. The third sample was a porous ceramic structure that was formed with only the starch pore former and was produced with pores having an average pore diameter or diameter of about 3 and about 7 μm. As is evident, the gas permeability is greatest for the first sample.

### EXAMPLE 2

Preparation of composite oxygen transport membrane consisting of high-connectivity porous LSFC+20 wt % Pd/Ag support and a dense LSFC layer.

About sixty grams of LSFC powder having average particle size of 1 μm, about fifteen grams of Pd/Ag powder having average particle size of about 1 μm, twenty grams of naphthalene powder having particle sizes of less than about 100 μm, and about 5 grams of starch having a particle size of less than about 10 μm were put into a plastic vial with a few methacrylate mixing balls. The LSFC powder contained a binding agent formed of about 5% by weight of polyvinyl alcohol and polyethylene glycol. The vial was then inserted into a SPEX CERTIPREP Mixer/Mill and mixed for about 10 minutes. About seven and a half grams of the prepared powder mixture was loaded into a stainless steel mold with a diameter of about 38 mm and pressed under the pressure of about 60 MPa for about 1 minute. After the pressure was released, the disc-shaped green form was withdrawn from the mold and put on the hot plate heating the green form to about 70° C. for about 2 hours to remove the naphthalene pore former to produce a green form of the present invention. The green form was then loaded into a furnace and heated at about 2° C./minute under ambient air to a temperature of about 1250° C. for about 4 hours. The furnace was cooled to room temperature at the rate of about 2° C./minute. The porous support so produced had a porosity of about 42% measured by mercury porosimetry.

The porous LSFC+20 wt % Pd/Ag disc was then deposited by plasma spraying with a dense LSFC layer under standard coating deposition conditions. As discussed above, FIG. 3 shows a cross-section of the resulting structure. Dense layer 14 has a thickness of about 100 μm. As shown, dense layer 14 is closely bonded with porous support 16. Within porous support 16, pores 18 have pore sizes or average diameters ranging from between about 20_μm and about 70_μm.

A high temperature permeation test was conducted on such composite disc at 1000° C. using air as a feed gas in the dense layer side and a reactive purge containing 85 percent by volume of hydrogen and 15 percent by volume of carbon dioxide mixture. An oxygen flux of about 33.5 sccm/cm² was demonstrated.

Although the present invention has been described with reference to preferred embodiments, as will occur to those skilled in the art, numerous changes, omissions, and additions may be made without departing from the spirit and scope of the present invention.

We claim:

1. A method of making a porous, green form for use in producing at least part of an article, said method comprising:
combining a green powder, a binding agent, and first and second pore forming, particulate materials to form a mixture;
the first pore forming, particulate material having a first particle size greater than a second particle size of the second pore forming, particulate material so that the first and second pore forming, particulate materials are able to produce pores and channels bridging the pores, respectively, within the article, upon removal of the first and second pore forming particulate materials;
forming the mixture into a configuration suitable for the use within the at least part of the article; and
removing at least the first pore forming, particulate material from the mixture after the mixture is formed into the configuration to form the pores.

2. The method of claim 1, wherein:
the first pore forming, particulate material is a first substance capable of being removed by sublimation; and
the first substance is removed from the mixture by sublimation, after the mixture is formed into the configuration of the green form and prior to removal of the second substance.

3. The method of claim 2, wherein the first substance is naphthalene and the second substance is carbon or starch.

4. The method of claim 2, wherein the first substance is naphthalene and the second substance is starch.

5. The method of claim 3 or claim 4, further comprising heating said green form or subjecting said green form to a sub-atmospheric pressure to accelerate said sublimation.

6. The method of claim 3 or claim 4, wherein said second particle size is between about 5 and about 30 times smaller than said first particle size.

7. The method of claim 6, wherein:
said second substance is present within the mixture in about 5% by weight and about 20% by weight; and
the second substance is removed by burning off said second substance.

8. The method of claim 7, further comprising heating said green ceramic component or subjecting said green ceramic component to a sub-atmospheric pressure to accelerate said sublimation.

9. The method of claim 1 or claim 2 or claim 3, wherein said green powder is a ceramic membrane material capable of conducting oxygen ions.

10. The method of claim 8, wherein said green powder is a ceramic membrane material capable of conducting oxygen ions.

11. The method of claim 1 or claim 2 or claim 3, wherein said green powder is a non-oxygen ion conducting ceramic material comprising alumina or magnesium oxide.

12. The method of claim 8, wherein said green powder is a non-oxygen ion conducting ceramic material comprising alumina or magnesium oxide.

13. The method of claim 1 or claim 2 or claim 3, wherein said green powder is a metallic material.

14. The method of claim 8, wherein said green powder is a metallic material.

15. An oxygen transport membrane comprising a dense layer and at least one porous support layer connected to the dense layer, the at least one porous support layer having pores and channels having average diameters less than that of the pores connecting the pores.

16. The oxygen transport membrane of claim 15, wherein said dense layer and said at least one porous support layer are formed from ceramic materials capable of conducting oxygen ions and elections.

17. The oxygen transport membrane of claim 16, wherein said dense layer and said at least one porous support layers are formed from the same material.

18. The oxygen transport membrane of claim 16 or claim 17, wherein:
said dense layer has a thickness in a thickness range of between about_{—}1 μm_ and about 1000 μm;
said pores have an average pore diameter in a pore diameter range of between about 0.1 μm and about 200 μm;
said channels have an average channel diameter of between about 5 and about 30 times smaller than said average pore diameters; and
said at least one porous support layer has a porosity of between about 30% and about 50% by volume.

19. The oxygen transport membrane of claim 18, wherein said pore diameter range is between about 20 μm and about 100 μm.
